(19) United States
(12) Patent Application Publication
(10) Pub. No.: US 2014/0347841 A1
(43) Pub. Date: Nov. 27, 2014

(54) LIGHTING APPARATUS

(71) Applicant: LITE-ON IT CORPORATION, Taipei (TW)

(72) Inventors: Sheng-Hsiung HU, Hsinchu (TW); Wei-Wen SHIH, Hsinchu (TW); Wen-Kwei LIANG, Hsinchu (TW); Chung-Dao CHEN, Hsinchu (TW)

(73) Assignee: LITE-ON IT CORPORATION, Taipei (TW)

(21) Appl. No.: 14/195,067

(22) Filed: Mar. 3, 2014

(30) Foreign Application Priority Data
May 21, 2013 (TW) 102117915

(51) Int. Cl. F21K 99/00

(52) U.S. Cl. CPC F21K 9/56
USPC 362/84; 362/311.02; 362/308

(57) ABSTRACT

A lighting apparatus including a base, a light cover, an optical element, and at least a light emitting element is provided. The light cover having a first opening is disposed on the base and together with the base forms a space. The optical element is fixed on the light cover and substantially covers the first opening of the light cover. The light emitting element is disposed in the space. A light emitted by the light emitting element passes through the optical element and emits from the light cover to form an illumination property of the lighting apparatus, wherein the light cover together with the optical element is movable with respect to the light emitting element. When the light cover and the optical element have different relative positions with respect to the light emitting element, the illumination properties are different.

This application claims the benefit of Taiwan application Serial No. 102117915, filed May 21, 2013, the subject matter of which is incorporated herein by reference.

### BACKGROUND OF THE INVENTION

1. Field of the Invention

The present disclosure relates in general to a lighting apparatus, and more particularly to a lighting apparatus with adjustable illumination property.

2. Description of the Related Art

Light emitting diode (LED) bulbs, having the characteristics of low power consumption and high brightness, have become more and more popular. However, most current lamps (such as bulb lamps, projection lamps, and recessed lamps) have fixed light pattern(s) and color temperature(s), which are difficult to be adjusted by a user. If a user has different requirements regarding the light patterns and the color temperature(s), the user needs to replace the current lamp with a lamp having different light pattern(s) and color temperature(s).

Currently, commonly used methods for adjusting the color temperatures or the color appearances are such as employing several LEDs provided with different color temperatures or color appearances controlled by IC elements; or controlling the lighting intensities of LEDs in different regions with electric signals to adjust the light patterns. However, the above-mentioned methods require arrangements of a large number of LEDs, and the IC elements used for controlling electric signals incur extra power consumption and increase costs. Therefore, an effective solution is still unavailable.

### SUMMARY OF THE INVENTION

The present disclosure is directed to a lighting apparatus. According to the embodiments, by moving the light cover with respect to the light emitting element, the relative position of the light emitting element with respect to the optical element can be adjusted and changed. Accordingly, the optical property of the emitted light changes as the relative position of the light cover with respect to the light emitting element varies, such that the illumination property of the lighting apparatus can be adjusted.

According to an embodiment of the present disclosure, a lighting apparatus is provided. The lighting apparatus includes a base, a light cover, an optical element, at least a light emitting element. The light cover has a first opening. The light cover is disposed on the base and together with the base forms a space. The optical element is fixed on the light cover and substantially covers the first opening of the light cover. The light emitting element is disposed in the space. A light emitted by the light emitting element passes the optical element and emits from the light cover to form an illumination property of the lighting apparatus. The light cover together with the optical element is movable with respect to the light emitting element. When the light cover and the optical element have a first relative position with respect to the light emitting element, the illumination property is a first illumination property. When the light cover and the light emitting element have a second relative position with respect to the light emitting element, the illumination property is a second illumination property, which is different from the first illumination property.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIGS. 1A-1B are stereoscopic cross-sectional views of a lighting apparatus according to an embodiment of the present disclosure;

FIGS. 2A-2B are top views of a lighting apparatus according to an embodiment of the present disclosure;

FIGS. 3A-3B are partial cross-sectional views along the section line 2A-2A′ in FIG. 2A and the section line 2B-2B′ in FIG. 2B, respectively;

FIGS. 4A-4B are stereoscopic cross-sectional views of a lighting apparatus according to another embodiment of the present disclosure;

FIGS. 5A-5B are top views of a lighting apparatus according to another embodiment of the present disclosure;

FIGS. 6A-6B are partial cross-sectional views along the section line 5A-5A′ in FIG. 5A and the section line 5B-5B′ in FIG. 5B, respectively;

FIGS. 7A-7B are stereoscopic cross-sectional views of a lighting apparatus according to a further embodiment of the present disclosure;

FIGS. 8A-8B are top views of a lighting apparatus according to a further embodiment of the present disclosure;

FIGS. 9A-9B are partial cross-sectional views along the section line 8A-8A′ in FIG. 8A and the section line 8B-8B′ in FIG. 8B, respectively;

FIGS. 10A-10B are stereoscopic cross-sectional views of a lighting apparatus according to a still further embodiment of the present disclosure;

FIGS. 11A-11B are top views of a lighting apparatus according to a still further embodiment of the present disclosure; and

FIGS. 12A-12B are partial cross-sectional views along the section line 11A-11A′ in FIG. 11A and the section line 11B-11B′ in FIG. 11B, respectively.

### DETAILED DESCRIPTION OF THE INVENTION

According to the embodiments of the present disclosure, by moving the light cover with respect to the light emitting element, the relative position of the light emitting element with respect to the optical element can be adjusted and changed. Accordingly, the optical property of the emitted light changes as the relative position of the light cover with respect to the light emitting element varies, such that the illumination property of the lighting apparatus can be adjusted. Detailed descriptions of the embodiments of the present disclosure are elaborated below with accompanying drawings. The identical or similar elements of the embodiments are designated with the same reference numerals. It should be noted that the accompanying drawings are simplified for the convenience of describing the embodiments of the disclosure, and detailed structures disclosed in the embodiments of the disclosure are for detailed descriptions only, not for limiting the scope of protection of the present disclosure. Anyone who is skilled in the technology field of the present disclosure can make necessary modifications or changes to these structures according to the needs in practical implementations.

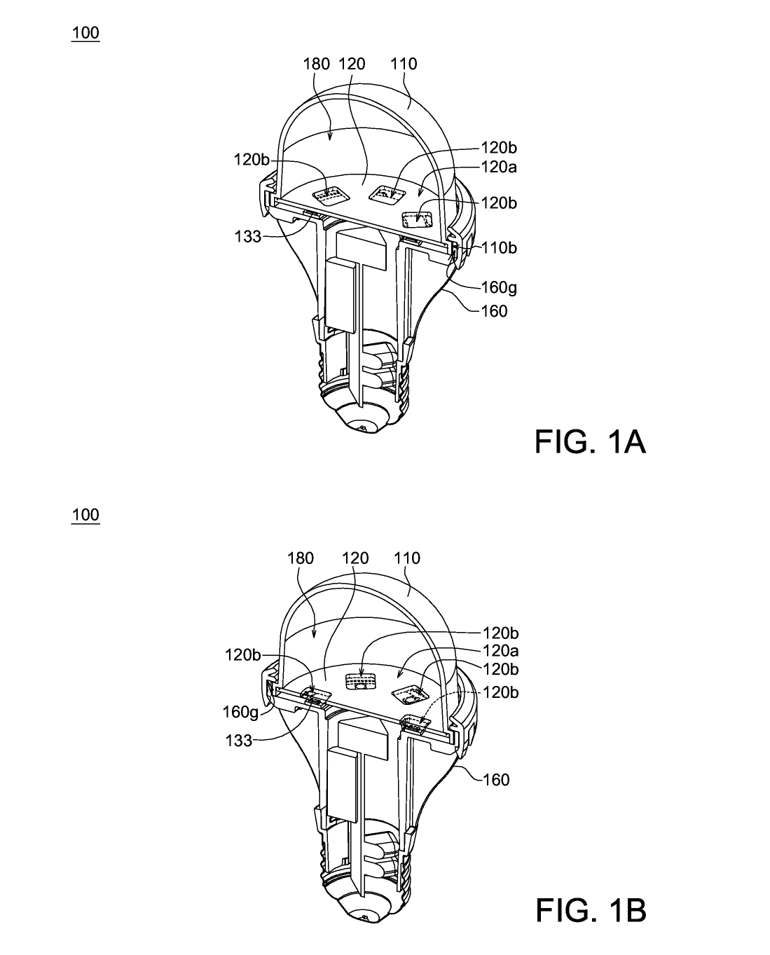

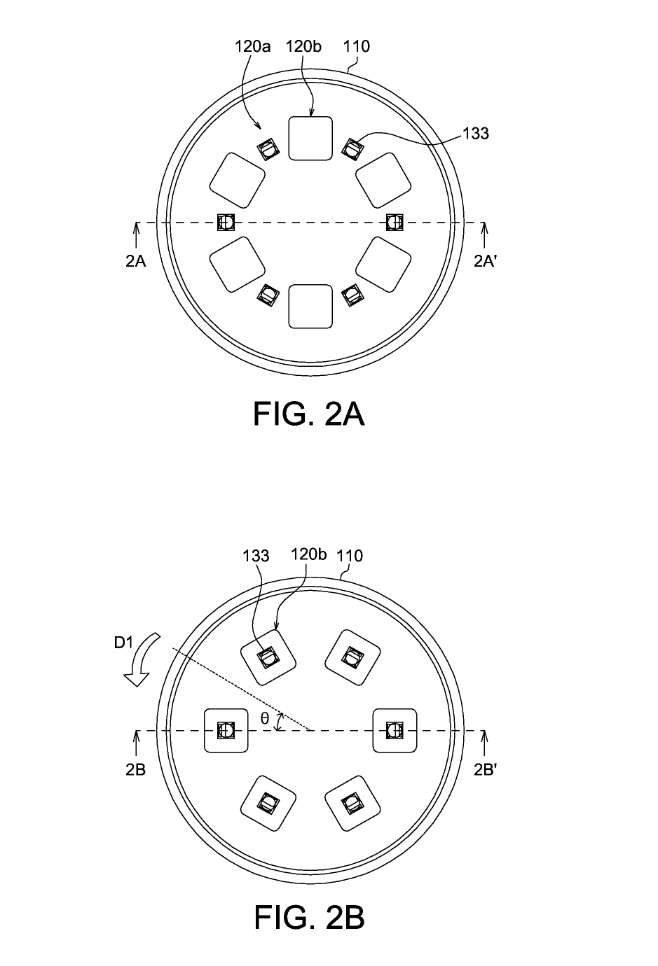

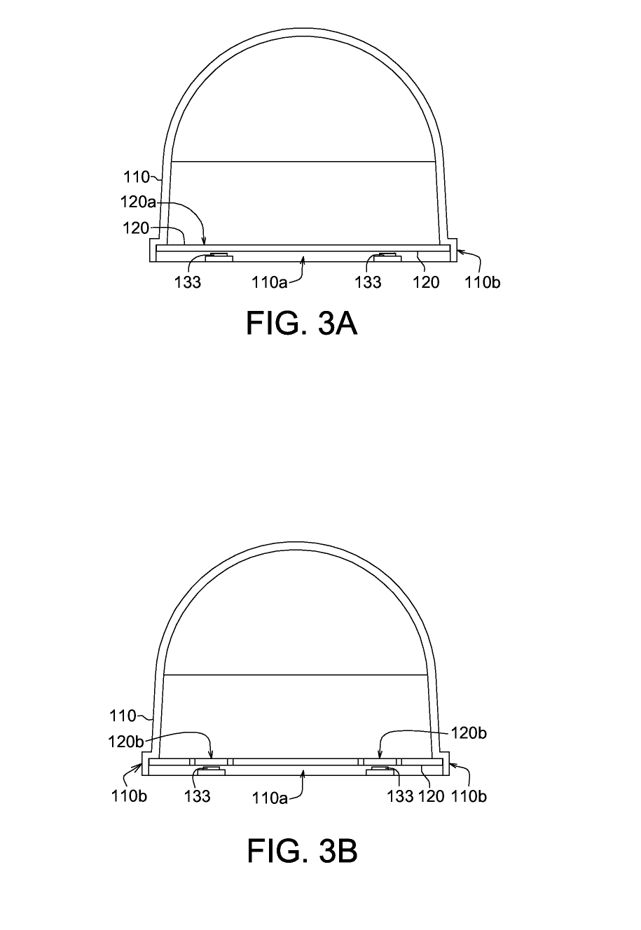

FIGS. 1A-1B are stereoscopic cross-sectional views of a lighting apparatus 100 according to an embodiment of the present disclosure, FIGS. 2A-2B are top views of the lighting apparatus 100 according to an embodiment of the present disclosure, and FIGS. 3A-3B are partial cross-sectional views along the section line 2A-2A′ in FIG. 2A and the section line 2B-2B′ in FIG. 2B, respectively.

Referring to FIGS. 1A, 2A, and 3A, the light apparatus 100 includes a light cover 110, an optical element 120, a base 160, and at least a light emitting element 133. The light cover 110 is disposed on the base 160. The light cover 110 together with the base 160 forms a space 180. The light cover 110 has a first opening 110a. The optical element 120 is disposed at the first opening 110a and substantially covers the first opening 110a of the light cover 110. The optical element 120 is fixed on the light cover 110, and the optical element 120 together with the light cover 110 is movable with respect to the light emitting element 133. The light emitting element 133 is disposed in the space 180, and the optical element 120 is dispose between the light cover 110 and the light emitting element 133. A light emitted by the light emitting element 133 enters the optical element 120 and then emits from the light cover 110, so that an illumination property of the light apparatus 100 is formed. In an embodiment, the light emitting element 133 is disposed on the base 160 and corresponding to the first opening 110a. In an embodiment, the optical element 120 can be fixed on the light cover 110 via a connection mechanism or by forming the optical element 120 and the light cover 110 integrally.

In the present embodiment, the light cover 110 and the optical element 120 can move with respect to the light emitting element 133. When the light cover 110 and the optical element 120 have a first relative position with respect to the light emitting element 133, the light emitted by the light emitting element 133 passes through the optical element 120 and then emits from the light cover 110 to form a first illumination property of the light apparatus 100. When the light cover 110 and the optical element 120 have a second relative position with respect to the light emitting element 133, the light apparatus 100 has a second illumination property. The first illumination property is different from the second illumination property. In the present embodiment, the illumination property is such as color temperature, color appearance, range of illumination, and/or light pattern.

In the present embodiment, the optical element 120 has a first optical property region 120a and a second optical property region 120b for producing lights with a first optical property and with a second optical property, respectively. In other words, after a light passes through the first optical property region 120a, a light with the first optical property is formed; and when a light passes through the second optical property region 120b, a light with a second optical property is formed. The first optical property is different from the second optical property. In the present embodiment, the optical property is such as the wavelength and/or the travelling path of a light. Moreover, when the light cover 110 and the optical element 120 have the first relative position with respect to the light emitting element 133, the light emitting element 133 is corresponding to the first optical property region 120a of the optical element 120. When the light cover 110 and the optical element 120 have the second relative position with respect to the light emitting element 133, the light emitting element 133 is corresponding to the second optical property region 120b.

In an embodiment, the optical property is such as wavelength. The first optical property region 120a of the optical element 120 has a first fluorescent material, and the second optical property region 120b has a second fluorescent material different from the first fluorescent material. A fluorescent material can change the wavelength of a light when it passes through the fluorescent material. An incident light is absorbed by the fluorescent material and converted into an emitted light with a different wavelength from that of the incident light. Since the light cover 110 and the optical element 120 are fixed to each other, and the light cover 110 together with the optical element 120 is movable with respect to the light emitting element 133; therefore, the light emitting element 133 can be optionally corresponding to the first optical property region 120a or the second optical property region 120b of the optical element 120 by moving the light cover 100 to different positions, for producing lights with different wavelengths.

In the present embodiment, the optical property is such as wavelength, and the illumination property is such as color temperature or color appearance. As shown in FIGS. 1A, 2A, and 3A, when the light cover 110 and the optical element 120 have the first relative position with respect to the light emitting element 133, the light emitting element 133 is corresponding to the first optical property region 120a of the optical element 120. At present, the light emitted by the light emitting element 133 passes through the first fluorescent material of the first optical property region 120a, and the light does not pass through the second fluorescent material of the second optical property region 120b. Accordingly, a light with a first wavelength is produced, rendering the light apparatus 100 with an illumination property of a first color temperature or a first color appearance. When the light cover 110 and the optical element 120 move by an angle θ with respect to the light emitting element 133, such as moving along the counter clock direction D1, as shown in FIGS. 1B, 2B, and 3B, the light cover 110 and the optical element 120 have the second relative position with respect to the light emitting element 133, and the light emitting element 133 is corresponding to the second optical property region 120b of the optical element 120. As such, the light emitted by the light emitting element 133 passes through the second fluorescent material of the second optical property region 120b, and the light does not pass through the first fluorescent material of the first optical property region 120a. Accordingly, a light with a second wavelength is produced, rendering the light apparatus 100 with an illumination property of a second color temperature or a second color appearance. Lights passing through fluorescent materials of different optical property regions produce lights with different color appearances or different color temperatures, and thus different illumination properties with different color appearances or different color temperatures are formed.

According to the embodiments of the present disclosure, the relative positions between the light emitting element 133 and the optical property regions 120a, 120b can be changed by moving the light cover 110 to move the light cover 110 and the optical element 120 with respect to the light emitting element 133. As such, lights emitted by the light emitting element 133 can selectively pass through one of different optical property regions for producing lights with relative one of different optical properties, and the effects of making the lighting apparatus 100 have different illumination properties can be achieved. In addition, the light cover 110 and the optical element 120 move with respect to the light emitting element 133 via a mechanical adjustment mechanism, which is more reliable than an electrical controlling mechanism, and the manufacturing cost for the mechanical adjustment mechanism is relatively low. However, the above-mentioned details of the present embodiment are for illustration only, and the moving angle and the moving direction of the light cover 110 with respect to the light emitting element 133 are not limited thereto; any mechanism can do as long as the movement of the light cover 110 can change the relative positions of the light emitting element 133 with respect to the optical property regions 120a, 120b for further changing the illumination property of the lighting apparatus 100.

As shown in FIGS. 1A-1B and 3A-3B, a base portion of the light cover 110 may have a flange 110b, and the base 160 may have a groove 160g. The flange 110b is movably fastened to the groove 160g, such that the light cover 110 can be disposed on the base 160, and the light cover 110 can be movable with respect to the base 160.

In addition, in order to control the movement range of the light cover 110, as well as the optical element 120, the light cover 110 and the base 160 can be disposed with a plurality of restricting mechanisms (not shown) thereon. Each of the restricting mechanisms may include, such as, a trench located in the flange 110b of the light cover 110 and a lever disposed in the groove 160g of the base 160, and the lever is corresponding to the trench. In the present embodiment, the movement range of the light cover 110, as well as the optical element 120, can be limited within the range of each of the spacing between every two light emitting elements 133 by the restricting mechanisms. However, the above-mentioned embodiments are for illustration only, and the present disclosure is not limited to the details of the restricting mechanisms as above-mentioned; any mechanism can do as long as the movement range of the light cover 110, as well as the optical element 120, can be controlled.

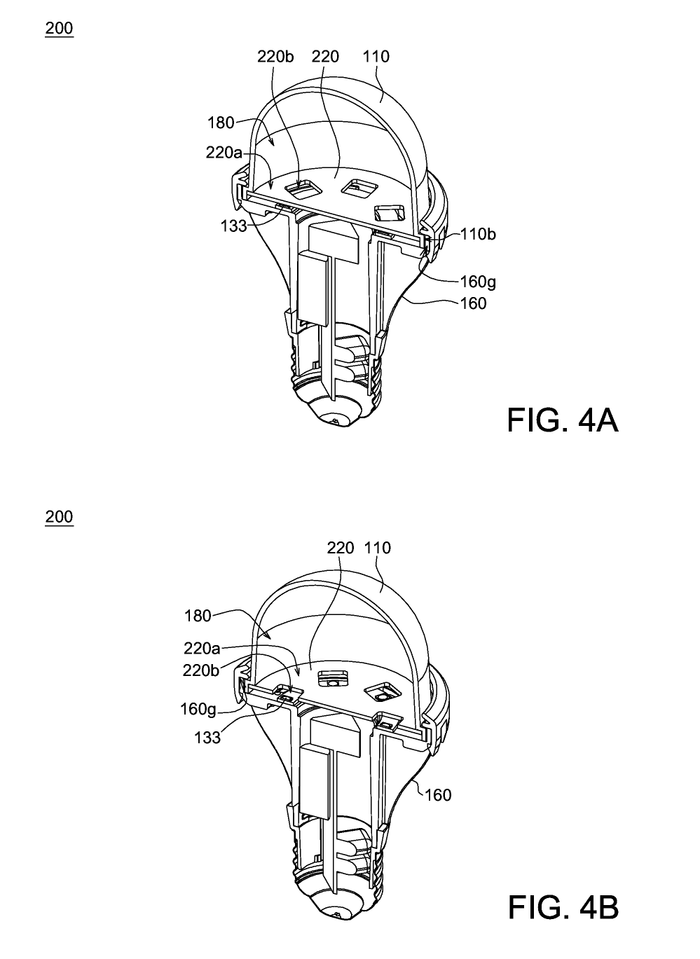

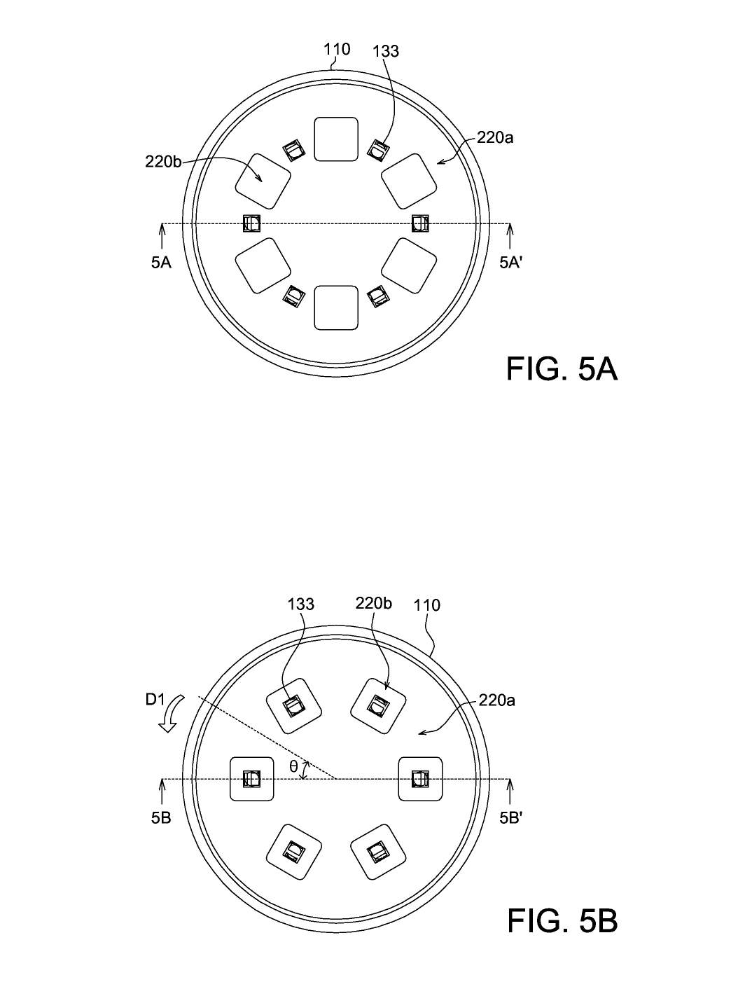

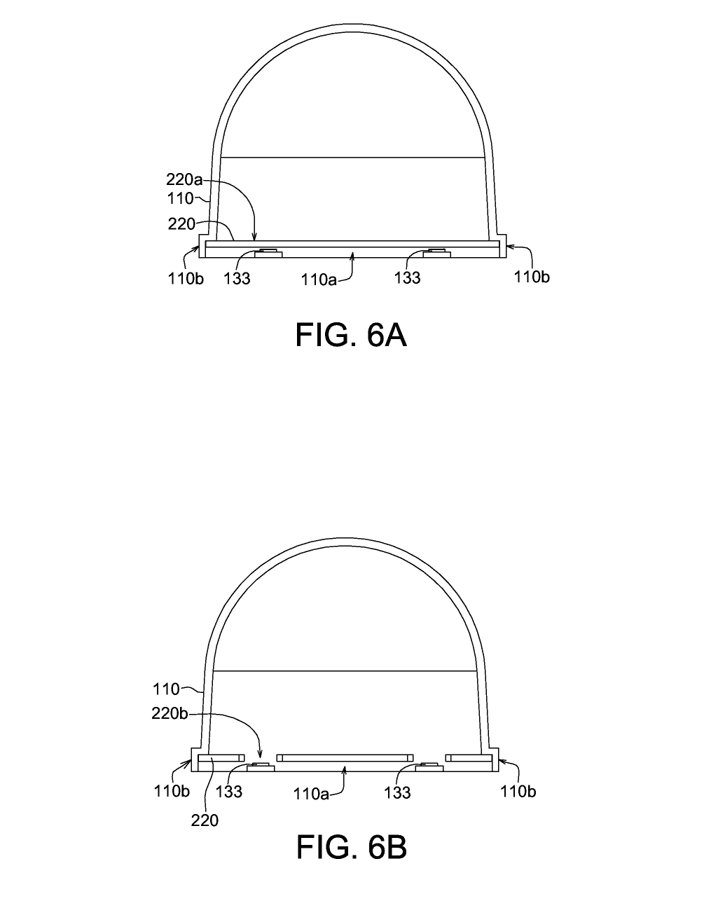

FIGS. 4A-4B are stereoscopic cross-sectional views of a lighting apparatus according to another embodiment of the present disclosure, FIGS. 5A-5B are top views of a lighting apparatus according to another embodiment of the present disclosure, and FIGS. 6A-6B are partial cross-sectional views along the section line 5A-5A′ in FIG. 5A and the section line 5B-5B′ in FIG. 5B, respectively. The light apparatus 200 of the present embodiment is different from the light apparatus 100 of the previous embodiment in the design of the optical element 220, and the similarities are not repeated here.

In the present embodiment, the light apparatus 200 includes a light cover 110, an optical element 220, a base 160, and at least one light emitting element 133. The light cover 110 is disposed on the base 160 and together with which forms a space 180. The optical element 220 is disposed at the first opening 110a of the light cover 110 and substantially covers the first opening 110a of the light cover 110. The optical element 220 is fixed on the light cover 110. The optical element 220 and the light cover 110 are together movable with respect to the light emitting element 133. The light emitting element 133 is disposed in the space 180, and the optical element 220 is disposed between the light cover 110 and the light emitting element 133. The light emitted by the light emitting element 133 enters the optical element 220 and then emits from the light cover 110 to form an illumination property of the light apparatus 200.

In the present embodiment, the optical element 220 has a first optical property region 220a and a second optical property region 220b for producing lights with a first optical property and with a second optical property, respectively. In other words, after a light passes through the first optical property region 220a, a light with a first optical property is formed; and when a light passes through the second optical property region 220b, a light with a second optical property is formed. The first optical property is different from the second optical property. In the present embodiment, the optical property is such as the wavelength and/or the travelling path of a light. Moreover, when the light cover 110 and the optical element 220 have a first relative position with respect to the light emitting element 133, the light emitting element 133 is corresponding to the first optical property region 220a of the optical element 220, and the lighting apparatus 200 has a first illumination property. When the light cover 110 and the optical element 220 have a second relative position with respect to the light emitting element 133, the light emitting element 133 is corresponding to the second optical property region 220b, and the lighting apparatus 200 has a second illumination property different from the first illumination property.

In the present embodiment, the optical property is such as wavelength. The first optical property region 220a of the optical element 220 has a fluorescent material, and the second optical property region 220b is such as an opening or a light-transmitting element having no fluorescent material. The optical property of a light remains unchanged as it passes through the second optical property region 220b. Since the light cover 110 and the optical element 220 are fixed to each other, and the light cover 110 together with the optical element 220 can move with respect to the light emitting element 133; accordingly, the light emitting element 133 can be optionally corresponding to the first optical property region 220a or the second optical property region 220b of the optical element 220 by moving the light cover 110 to different positions, for producing lights with different color temperatures or wavelengths.

In the present embodiment, the optical property is such as wavelength, and the illumination property is such as color temperature or color appearance. As shown in FIGS. 4A, 5A, and 6A, when the light cover 110 and the optical element 220 have a first relative position with respect to the light emitting element 133, the light emitting element 133 is corresponding to the first optical property region 220a of the optical element 220. At present, the light emitted by the light emitting element 133 passes through the fluorescent material of the first optical property region 220a, and the light does not pass through the second optical property region 220b. Accordingly, a light with a first wavelength is produced, rendering the light apparatus 200 with an illumination property of a first color temperature or a first color appearance. When the light cover 110 and the optical element 220 move by an angle θ with respect to the light emitting element 133, such as moving along the counter clock direction D1, as shown in FIGS. 4B, 5B, and 6B, the light cover 110 and the optical element 220 have a second relative position with respect to the light emitting element 133, and the light emitting element 133 is corresponding to the second optical property region 220b of the optical element 220. As such, the light emitted by the light emitting element 133 passes through the second optical property region 220b having no fluorescent material, and the light does not pass through the fluorescent material of the first optical property region 220a. Accordingly, a light with a second wavelength is produced, rendering the light apparatus 200 with an illumination property of a second color temperature or a second color appearance. Lights passing through a fluorescent material or not can produce lights with different color appearances or different color temperatures, and thus different illumination properties with different color appearances or different color temperatures are formed.

According to the embodiments of the present disclosure, the relative positions between the light emitting element 133 and the optical property region 220b can be changed by moving the light cover 110 to move the light cover 110 together with the optical element 120 with respect to the light emitting element 133. As such, the light emitting element 133 can be shifted away from the second optical property region 220b, and a light can pass through the first optical property region 220a with a fluorescent material for producing a light with an optical property different from that of a light passing through the second optical property region 220b, and the effects of making the lighting apparatus 200 have different illumination properties can be achieved. However, the above-mentioned details of the present embodiment are for illustration only, and the moving angle and the moving direction of the light cover 110 with respect to the light emitting element 133 are not limited to the embodiment aforementioned; any mechanism can do as long as the movement of the light cover 110 can change the relative positions of the light emitting element 133 with respect to the second optical property regions 220b for further changing the illumination property of the lighting apparatus 200.

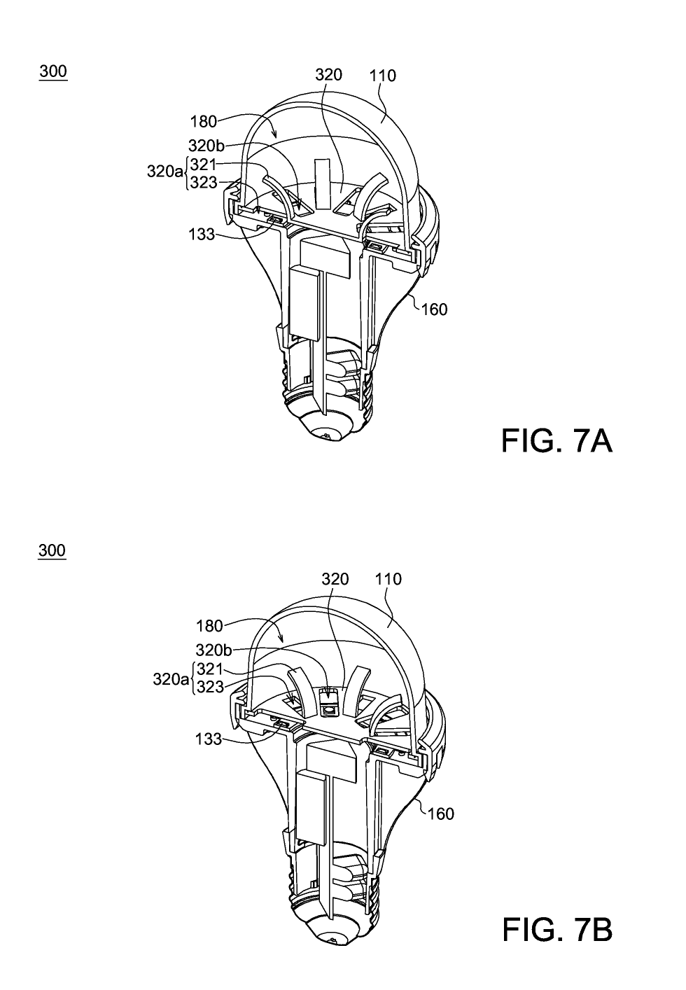

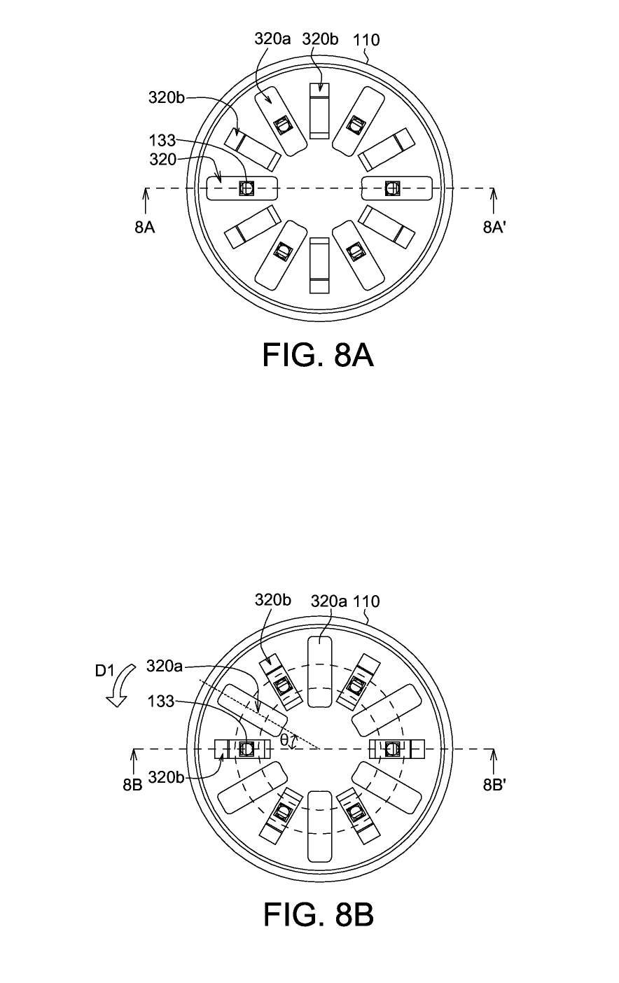

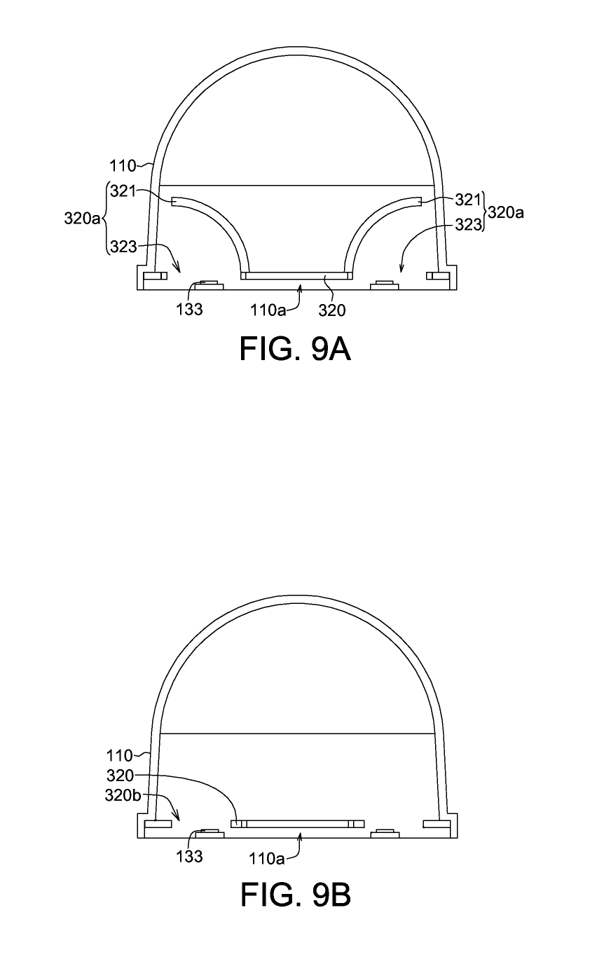

FIGS. 7A-7B are stereoscopic cross-sectional views of a lighting apparatus according to a further embodiment of the present disclosure, FIGS. 8A-8B are top views of a lighting apparatus according to a further embodiment of the present disclosure, and FIGS. 9A-9B are partial cross-sectional views along the section line 8A-8A′ in FIG. 8A and the section line 8B-8B′ in FIG. 8B, respectively. The lighting apparatus 300 of the present embodiment is different from the lighting apparatus 100 of the previous embodiment in the design of the optical element 320, and the similarities are not repeated here.

In the present embodiment, the lighting apparatus 300 includes a light cover 110, an optical element 320, a base 160, and at least one light emitting element 133. The light cover 110 is disposed on the base 160 and together with which forms the space 180. The optical element 320 is disposed at the first opening 110a of the light cover 110 and substantially covers the first opening 110a of the light cover 110. The optical element 320 is fixed on the light cover 110. The optical element 320 together with the light cover 110 is movable with respect to the light emitting element 133. The light emitting element 133 is disposed in the space 180, and the optical element 320 is disposed between the light cover 110 and the light emitting element 133. The light emitted by the light emitting element 133 enters the optical element 320 and then emits from the light cover 110 to form an illumination property of the lighting apparatus 300.

In the present embodiment, the optical element 320 has a first optical property region 320a and a second optical property region 320b for producing lights with a first optical property and a second optical property, respectively. In other words, after a light enters the first optical property region 320a, a light with the first optical property is formed; after a light enters the second optical property region 320b, a light with the second optical property is formed. The first optical property is different from the second optical property. In the present embodiment, the optical property is such as wavelength and/or travelling path of a light. Moreover, when the light cover 110 and the optical element 320 have a first relative position with respect to the light emitting element 133, the light emitting element 133 is corresponding to the first optical property region 320a of the optical element 320, and the lighting apparatus 300 has a first illumination property. When the light cover 110 and the optical element 320 have a second relative position with respect to the light emitting element 133, the light emitting element 133 is corresponding to the second optical property region 320b of the optical element 320, and the lighting apparatus 300 has a second illumination property different from the first illumination property.

In an embodiment, the optical property is such as the travelling path of a light. As shown in FIGS. 7A, 8A, and 9A, the first optical property region 320a may comprise a secondary optical element 321. The secondary optical element 321 is not limited to any specific structure. The secondary optical element 321 is an optical component that may reflect, refract, or focus an incident light. The second optical property region 320b may be, for example, an opening or a light-transmitting element. The second optical property region 320b may also be another optical component that can reflect, refract, or focus an incident light. Since the light cover 110 and the optical element 320 are fixed to each other, and the light cover 110 together with the optical element 320 are movable with respect to the light emitting element 133; accordingly, the light emitting element 133 can be optionally corresponding to the first optical property region 320a or the second optical property region 320b of the optical element 320 for producing lights with different travelling paths.

According to the embodiments of the present disclosure, the first optical property region and the second optical property region of the optical element may be any combinations of an opening, a light-transmitting element, a secondary optical element (an optical component for reflecting, refracting, or focusing a light), or a fluorescent material, as long as the combination satisfies that the lights can have different optical properties after passing through different optical property regions, respectively. In addition, in an embodiment, a single optical property region may include a combination of a secondary optical element and a fluorescent material, which can change the color temperature or wavelength of a light and the travelling path of a light simultaneously.

In an embodiment, the optical property is such as the travelling path of a light. As shown in FIGS. 7A, 8A, and 9A, the first optical property region 320a has secondary optical elements 321 and openings 323. The secondary optical element 321 is such as a reflective plate. Each of the reflective plates (secondary optical elements 321) is disposed above each of the correspondingly opening 323, and the second optical property region 320b is such as an opening. Lights passed through the first optical property region 320a and through the second optical property region 320b have different travelling paths, such that the lighting apparatus 300 may produce different illumination properties. Since the light cover 110 and the optical element 320 are fixed to each other, and the light cover 110 together with the optical element 320 are movable with respect to the light emitting element 133; accordingly, the light emitting element 133 can be optionally corresponding to the first optical property region 320a or the second optical property region 320b of the optical element 320 for producing lights with different travelling paths.

In the present embodiment, the optical property is such as the travelling path of a light, and the illumination property is such as the illumination range or the light pattern. As shown in FIGS. 7A, 8A, and 9A, when the light cover 110 and the optical element 320 have the first relative position with respect to the light emitting element 133, the light emitting element 133 is corresponding to the first optical property region 320a of the optical element 320. At present, the light emitted by the light emitting element 133 is reflected by the reflective plate (secondary optical element 321), so that the travelling path of the light is changed, the light is turned into lateral illumination, and a light with a first travelling path is formed. Accordingly, the lighting apparatus 300 has an illumination property with a first illumination range or a first light pattern. When the light cover 110 and the optical element 320 move by an angle θ with respect to the light emitting element, such as moving along the counter clock direction D1, as shown in FIGS. 7B, 8B, and 9B, the light cover 110 and the optical element 320 have the second relative position with respect to the light emitting element 133, and the light emitting element is corresponding to the second optical property region 320b. As such, each of the reflective plates (secondary optical elements 321) is located in the middle of every two light emitting elements 133. At present, the light emitted by the light emitting element 133 passes through the opening of the second optical property region 320b directly without being reflected by any of the reflective plates. Accordingly, a light with a second travelling path is formed, making the lighting apparatus 300 have an illumination property with a second illumination range or a second light pattern.

In the present embodiment, the reflective plate may be a transparent lens. A portion of the light emitted by the light emitting element 133 passes through the reflective plate and emits upward, and another portion of the light is reflected and turns into lateral illumination. In the present embodiment, the reflective lens may be further uniformly mixed with a fluorescent material therein or coated with a fluorescent material on the surface thereof, such that the light passing through the reflective plate is absorbed and converted into a light with a different wavelength. As such, the lighting apparatus 300 may have illumination properties with different color temperatures, color appearances, illumination ranges, or light patterns.

According to the embodiments of the present disclosure, the relative positions of the light emitting element 133 with respect to the light cover 110 and the optical element 320 can be changed by moving the light cover 110, such that the relative positions of the light emitting element 133 with respect to the optical property region 320a (reflective plate) can be changed. As such, the light emitting element 133 can adjust to be aligned with or shifted from the optical property region 320a (reflective plate) in order to change the travelling path of a light, and the lighting apparatus 300 can be provided with different illumination properties, such as different light patterns or illumination ranges. However, the above-mentioned details of the present embodiment are for illustration only; the moving angle and the moving direction of the light cover 110 with respect to the light emitting element 133 and the design of the optical property regions 320a, 320b are not limited to the embodiment aforementioned; any mechanism can do as long as the movement of the light cover 110 can change the relative positions of the light emitting element 133 with respect to the optical property regions 320a, 320b for further changing the illumination property (light pattern/illumination range) of the lighting apparatus 300.

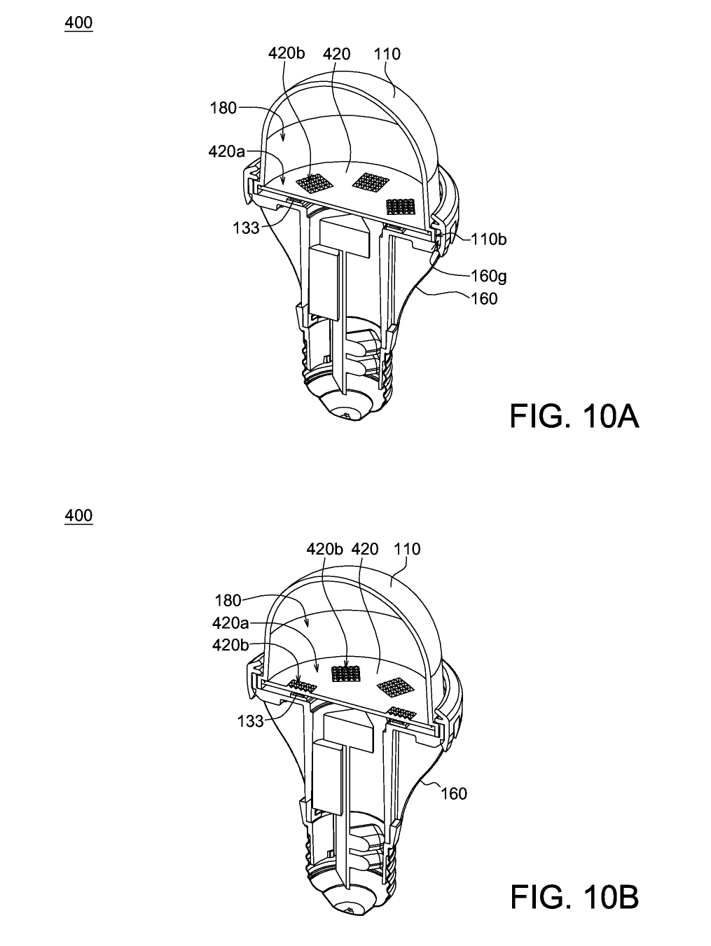

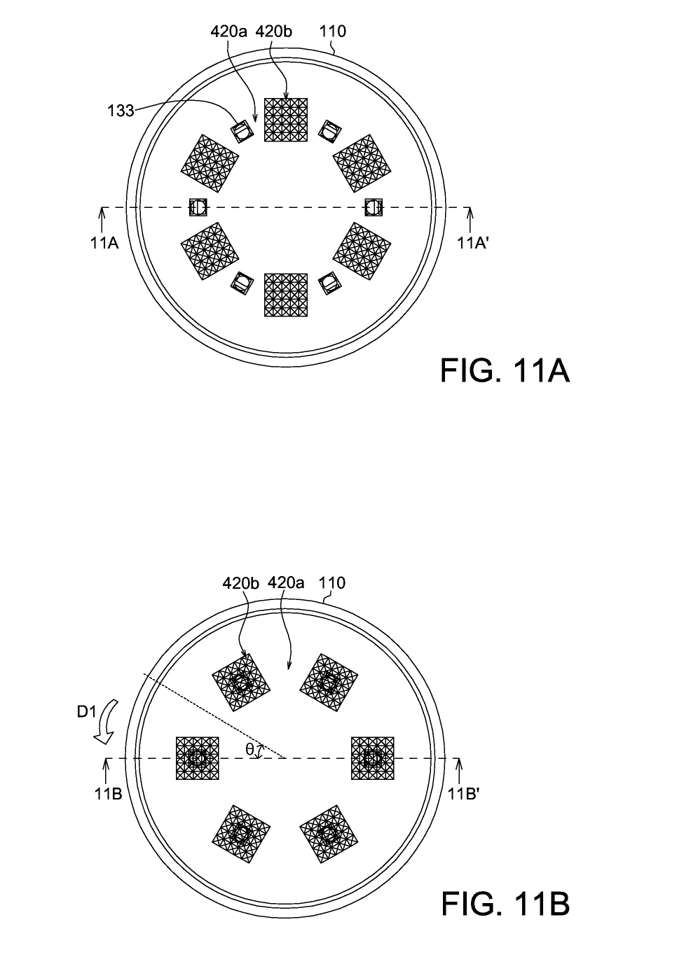

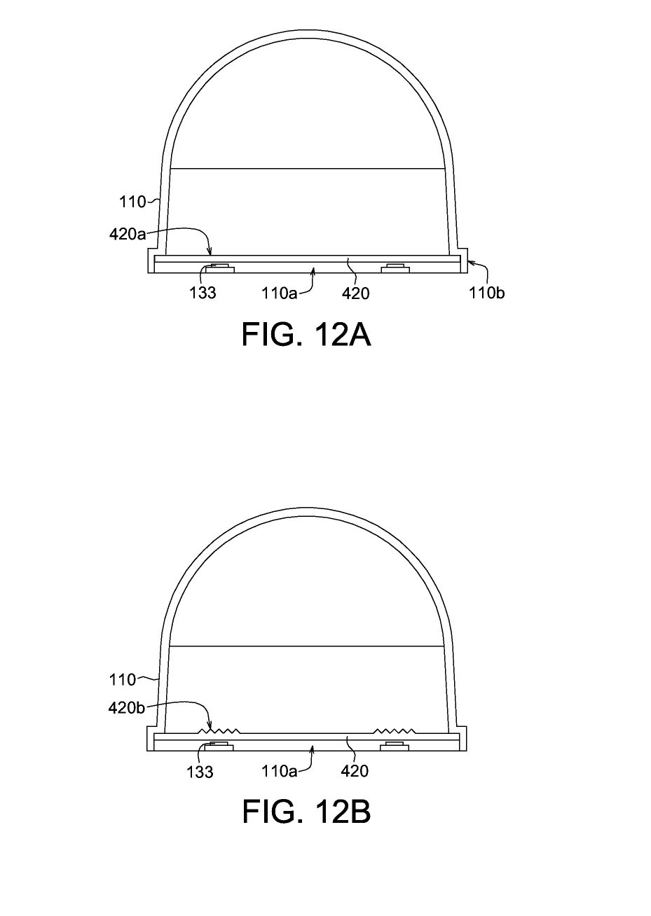

FIGS. 10A-10B are stereoscopic cross-sectional views of a lighting apparatus according to a still further embodiment of the present disclosure, FIGS. 11A-11B are top views of a lighting apparatus according to a still further embodiment of the present disclosure, and FIGS. 12A-12B are partial cross-sectional views along the section line 11A-11A′ in FIG. 11A and the section line 11B-11B′ in FIG. 11B, respectively. The lighting apparatus 400 of the present embodiment is different from the lighting apparatus 100 of the previous embodiment in the design of the optical element 420, and the similarities are not repeated here.

In the present embodiment, the lighting apparatus 400 includes a light cover 100, an optical element 420, a base 160, and at least one light emitting element 133. The light cover 110 is disposed on the base 160 and together with the base 160 forms the space 180. The optical element 420 is disposed at the first opening 110a of the light cover 110 and substantially covers the first opening 110a of the light cover 110. The optical element 420 is fixed on the light cover 110. The optical element 420 together with the light cover 110 is movable with respect to the light emitting element 133. The light emitting element 133 is disposed in the space 180, and the optical element 420 is disposed between the light cover 110 and the light emitting element 133. The light emitted by the light emitting element 133 passes through the optical element 420 and then emits from the light cover 110 for forming an illumination property of the lighting apparatus 400.

In the present embodiment, the optical element 420 has a first optical property region 420a and a second optical property region 420b for producing lights with a first optical property and a second optical property, respectively. In other words, after the light emits into the first optical property region 420a, a light with the first optical property is produced; after the light emits into the second optical property region 420b, a light with the second optical property is produced, and the first optical property is different from the second optical property. In the present embodiment, the optical properties are such as the wavelengths and/or the travelling paths of lights. Moreover, when the light cover 110 and the optical element 420 have a first relative position with respect to the light emitting element 133, the light emitting element 133 is corresponding to the first optical property region 420a of the optical element 420, and the lighting apparatus 400 has a first illumination property. When the light cover 110 and the optical element 420 have a second relative position with respect to the light emitting element 133, the light emitting element 133 is corresponding to the second optical property region 420b, and the lighting apparatus 200 has a second illumination property which is different from the first illumination property.

In an embodiment, the optical properties are such as the travelling paths of lights. As shown in FIGS. 10A, 11A, and 12A, the first optical property region 420a of the optical element 420 is such as a light-transmitting element, and the second optical property region 420b is such as a secondary optical element, which is such as a condensing lens. Since the light cover 110 together with the optical element 420 are movable with respect to the light emitting element 133, the light emitting element 133 can be optionally corresponding to the first optical property region 420a or the second optical property region 420b of the optical element 420 for producing lights with different travelling paths.

In an embodiment, as shown in FIGS. 10A-10B and 11A-11B, each of the condensing lenses (the secondary optical property region 420b) may include a plurality of prisms arranged on the optical element 420. The effects of condensing lights can be achieved by adjusting the number, the sizes, and the arrangements of the prisms.

In the present embodiment, the optical property is such as the travelling path of a light, and the illumination property is such as the illumination range or the light pattern. As shown in FIGS. 10A, 11A, and 12A, when the light cover 110 and the optical element 420 have the first relative position with respect to the light emitting element 133, the light emitting element 133 is corresponding to the first optical property region 420a of the optical element 420. At present, the light emitted by the light emitting element 133 does not pass the condensing lens to be refracted, so that a light with a first travelling path is formed. Accordingly, the lighting apparatus 400 has an illumination property with a first illumination range or a first light pattern. When the light cover 110 and the optical element 420 move by an angle θ with respect to the light emitting element 133, such as moving along the counter clock direction D1, as shown in FIGS. 10B, 11B, and 12B, the light cover 110 and the optical element 420 have the second relative position with respect to the light emitting element 133, and the light emitting element 133 is corresponding to the second optical property region 420b. As such, the light emitted by the light emitting element 133 passes through the condensing lens of the second optical property region 420b to be refracted and of which the travelling path is changed. The refracted light is condensed and emits upward; accordingly, a light with a second travelling path is formed, making the lighting apparatus 400 have an illumination property with a second illumination range or a second light pattern.

In another embodiment, the second optical property region 420b is such as a diverging lens which is movable with respect to the light emitting element 133. The diverging lens includes such as a plurality of prisms arranged on the optical element 420. In the embodiment, when the diverging lens (the secondary optical property region 420b) moves by an angle θ with respect to the light emitting element 133, such as moving along the counter clock direction, referring to FIGS. 10B, 11B, and 12B, the light cover 110 and the optical element 420 have the second relative position with respect to the light emitting element 133, and the light emitting element 133 is corresponding to the second optical property region 420b of the optical element 420. As such, the light emitted by the light emitting element 133 passes through the diverging lens of the second optical property region 420b to be refracted, of which the travelling path is changed for forming a lateral illumination, and a light with a second travelling path is produced, making the lighting apparatus 400 have an illumination property with the second illumination range/light pattern.

In an alternative embodiment, the first optical property region 420a of the optical element 420 is such as a diverging lens, and the second property region 420b is such as a condensing lens. Lights with different travelling paths are formed by changed the relative position of the optical element 420 with respect to the light emitting element 133, such that the lighting apparatus 400 may have different illumination properties with different illumination ranges/light patterns.

According to the embodiments of the present disclosure, by moving the light cover 110, the relative position of the light emitting element 133 with respect to the light cover 110 and the optical element 420 can be adjusted and changed. Accordingly, the relative position of the light emitting element 133 with respect to the optical property region 420b (the condensing lens or the diverging lens) is changed, such that the light emitting element 133 can adjust to be aligned with or shifted from the optical property region 420b (the condensing lens or the diverging lens) to refract lights, making the lighting apparatus 400 have different illumination properties with different light patterns/illumination ranges. However, the present embodiment is for exemplifying only. The moving angle and the moving direction of the light cover 110 with respect to the light emitting element 133 as well as the designs of the optical property regions 420a and 420b are not limited thereto, as long as the illumination property (light pattern/illumination range) of the lighting apparatus 400 can be changed by moving the light cover 100 to change the relative position of the light emitting element 133 with respect to the optical property regions 420a and 420b.

According to the lighting apparatus disclosed in the embodiments of the present disclosure, by adjusting the relative position of the light cover with respect to the light emitting element, the relative position of the light emitting element with respect to the optical element can be adjusted and changed. Accordingly, the optical property of the emitted light changes as the relative position of the light cover with respect to the light emitting element varies, such that the illumination property of the lighting apparatus can be adjusted. In addition, the movement of the light cover with respect to the light emitting element is carried out by a mechanical mechanism, which is more reliable than an electrical mechanism and requires less cost. Moreover, with the same number and brightness of the light emitting element(s), the light pattern and the color temperature of the lighting apparatus of the embodiments are changed by adjusting the travelling path and the wavelength of the light with the structural features of the optical element; thus, the efficiency is improved, and the cost is reduced, without additionally increasing the number of the light emitting elements. Furthermore, the optical element and the light emitting element are disposed in the space formed by the light cover and the base, such that the lighting apparatus can be provided with simple and beautiful appearance design while the illumination property is adjustable.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lighting apparatus, comprising:
a base;
a light cover, having a first opening, disposed on the base and together with the base forming a space;
an optical element fixed on the light cover and substantially covering the first opening of the light cover; and
at least a light emitting element disposed in the space, a light emitted by the light emitting element passing through the optical element and emitting from the light cover to form an illumination property of the lighting apparatus;
wherein the light cover together with the optical element is movable with respect to the light emitting element; when the light cover and the optical element have a first relative position with respect to the light emitting element, the illumination property is a first illumination property; when the light cover and the optical element have a second relative position with respect to the light emitting element, the illumination property is a second illumination property, and the first illumination property is different from the second illumination property.

2. The light apparatus according to claim 1, wherein the illumination property is at least one of color temperature, color appearance, direction, range, or light pattern of illumination.

3. The lighting apparatus according to claim 1, wherein the optical element has a first optical property region and a second optical property region, a light with a first optical property is formed as the light emitted by the light emitting element passes through the first optical property region, a light with a second optical property is formed as the light passes through the second optical property region, and the first optical property is different from the second optical property.

4. The light apparatus according to claim 3, wherein the first optical property and the second optical property are respectively at least one of the wavelength of the light or a travelling path of the light.

5. The light apparatus according to claim 3, wherein the first optical property region has a first fluorescent material, and the second optical property region has a second fluorescent material different from the first fluorescent material.

6. The light apparatus according to claim 3, wherein the first optical property region has a fluorescent material, and the second optical property region is an opening or a light-transmitting element without any fluorescent material.

7. The lighting apparatus according to claim 3, wherein the first optical property region has a secondary optical element.

8. The lighting apparatus according to claim 7, wherein the second optical property region is at least one of an opening, a light-transmitting element, or a secondary optical element.

9. The light apparatus according to claim 7, wherein the secondary optical element is at least one of a reflective optical component, a refractive optical component, or a focusing optical component.

10. The light apparatus according to claim 7, wherein the first optical property region and the second optical property region further have a fluorescent material, respectively.

11. The lighting apparatus according to claim 7, wherein the first optical property region further has an opening, and the secondary optical element is disposed above the opening.

12. The lighting apparatus according to claim 3, wherein the first optical property region is a light-transmitting element, and the second optical property region is at least one of a condensing lens or a diverging lens.

13. The light apparatus according to claim 12, wherein the condensing lens or the diverging lens includes a plurality of prisms arranged on the optical element.

14. The lighting apparatus according to claim 1, wherein a base portion of the light cover has a flange, and the flange is movably fastened to a groove of the base.

15. The lighting apparatus according to claim 1, wherein the light cover and the optical element are formed integrally.
